(19) United States
(12) Patent Application Publication
(10) Pub. No.: US 2002/0109131 A1
(43) Pub. Date: Aug. 15, 2002

(54) Redirective end treatment

(76) Inventors: Jeffery D. Smith, St. Charles, IL (US); Randy L. Warner, Harrisburg, PA (US); Les M. Okreglak, Carson City, NV (US); Paul I. Eckert, Carson City, NV (US); Robert B. Lauck, San Juan, Capistrano, CA (US)

Correspondence Address: NIXON & VANDERHYE P.C., 8th Floor, 1100 North Glebe Road, Arlington, VA, 22201, US

(21) Appl. No.: 09/783,393

(22) Filed: Feb. 15, 2001

(51) Int. Cl. A01K 3/00; E01F 15/00

(52) U.S. Cl. 256/13.1

(57) ABSTRACT

An improved redirective end treatment is disclosed which uses a braking system that provides a varied braking force to maintain the rate of deceleration of a vehicle impacting the end treatment at or below a predetermined value. The redirective end treatment includes a guardrail structure and an impact sled positioned ahead of the guardrail structure. Pivotally attached to the front of the guardrail structure is a smart braking unit positioned within the impact sled. When a vehicle collides with the impact sled, the sled is caused to translate backwards towards the braking unit and guardrail structure. As the impact sled collides with the braking unit, the guardrail structure is caused to move vertically and fold in a scissors-like action. The amount of linear space finally occupied by the end treatment is then reduced, but because the impact sled, braking unit and guardrail structure are not physically damaged they can be returned to their original positions for reuse.

### FIELD OF THE INVENTION

The present invention relates to vehicle crash barriers, and, in particular, to a novel end treatment for controlling the deceleration of vehicles that have left a roadway.

### BACKGROUND OF THE INVENTION

Most crash barriers that are deployed along roadways today to redirect or stop vehicles that have left a roadway use various structural arrangements in which the barrier compresses and/or collapses in response to the vehicle colliding with the barrier.

One crash barrier which uses a braking system in conjunction with a structural arrangement to decelerate vehicles is described in U.S. Pat. No. 5,022,782 to Gertz et al. The Gertz et al. crash barrier uses a multi-section elongated frame that is configured to collapse when axially struck on its front section by a vehicle. Each section of the Gertz et al. crash barrier includes a pair of side panels, with axially adjacent side panels overlapping and being connected together by a flexible tension strap that is fastened to the panels. The tension strap operates to peel the fasteners out of the side panels during axial collapse.

Gertz et al.'s arrangement also includes a tension member, such as a wire cable, which is engaged by friction brakes to generate a retarding force to decelerate a vehicle during collapse of the frame following impact of the vehicle against the frame's front section. The brakes include an abrading material, such as aluminum, which is used in a friction generating sleeve in contact with the wire cable. The brake sleeve is lubricated to reduce the static coefficient of friction and prevent the brake assembly from developing excessive retarding forces as it slides along the wire cable. Because spring plates provide a resilient biasing force that holds the brake sleeves against the wire cable, dimensional changes in the brake sleeve, as they are abraded, do not substantially alter the force with which the brake sleeves are pressed against the wire cable. Indeed, Gertz et al. make it abundantly clear that their resiliently biased brake means provides “a surprisingly constant retarding force in spite of variations in position and velocity of the brake means along the wire cable, and in spite of wide variations in the surface condition of the wire cable 122.” In the Gertz et al. arrangement, “water, dirt, and even lubricants on the wire cable do not have a major effect on the retarding force after the braking means is moved along the wire cable.” The Gertz et al. '782 patent, col. 10, line 67 to col. 11, line 24. Thus, the braking force provided by the Gertz et al. brakes is not intended to be varied in response to changes in the velocity of a vehicle impacting the Gertz et al. Barrier.

### SUMMARY OF THE INVENTION

The present invention is an improved redirective end treatment that uses a braking system that actively controls the rate at which a vehicle impacting the end treatment is decelerated to safely stop the vehicle. In particular, the present invention is a redirective end treatment that limits the velocity at which an unrestrained occupant of a crashing vehicle impacts the vehicle's dashboard and that actively controls the vehicle's rundown deceleration in accordance with the requirements of the National Cooperative Highway Research Program's recently issued report, NCHRP Report 350, for evaluating the safety performance of various highway safety devices, such as end treatments. Included in NCHRP Report 350 are recommendations for occupant impact with a vehicle's dashboard and subsequent rundown deceleration rates for the vehicle to be used in designing crash barriers that meet NCHRP Report 350's test levels 2, 3 and a new test level of 120 km/hr.

The redirective end treatment of the present invention includes a guardrail structure and an impact sled positioned ahead of the guardrail structure. The guardrail structure and the impact sled are slidably connected to two guide/brake rails that are attached to the ground. Attached to the front of the impact sled is an elastomer impact surface. Pivotally attached to the front of the guardrail structure is a smart braking unit which is also slidably connected to the guide/brake rails, and which is positioned within the impact sled ahead of the guardrail structure. When a vehicle hits the elastomer impact surface of the impact sled, the sled is caused to translate backwards towards the braking unit and guardrail structure. The elastomer absorbs a predetermined amount of energy from the vehicle impact to cushion an initial spike in the g-force caused by the sled accelerating to meet the speed of the vehicle. As the impact sled translates backwards, it first hits an energy-absorbing buffer before colliding with the braking unit attached to the guardrail structure. As the sled and braking unit move backwards, two lattice structures forming the guardrail structure are released from hold-down latches and caused to move vertically and fold in a scissors-like action that results from the two lattice structures pivoting around first and second pivot points. Springs positioned under the center of the lattice structures assist in the scissors-like folding action of the lattice structures. As a consequence of this vertical scissors-like folding action, the amount of linear space occupied by the sled, braking unit, and guardrail structure is substantially reduced. But because the sled, braking unit and guardrail structure are physically not damaged, compressed, or collapsed due to the vehicle impact, they can be returned to their original positions for reuse upon the release of the pressure in the braking system.

When the braking unit, after being impacted by the impact sled, has moved backwards a predetermined distance, a boost pressure apparatus causes maximum hydraulic pressure to build in the braking system so that maximum braking force is applied to the brake rails to decelerate a crashing vehicle. A g-force sensing valve then proportionately removes pressure from the braking system until the rate of deceleration of the crashing vehicle reaches a predetermined value corresponding to a predetermined g-force so that deceleration of the vehicle is maintained at or below that predetermined value. The g-force sensing valve senses whether the g-force experienced by the impacting vehicle, and, thus, the rate of deceleration of such vehicle impacting the impact sled is above the predetermined value. If it is above, the valve reduces the pressure in the braking system, and, thereby, reduces the braking force to bring the deceleration of the vehicle below the predetermined value. If it is below the predetermined value, the valve increases the pressure in the braking system to increase the rate of deceleration of the vehicle. Thus, the present invention uses a braking system which varies the braking force to control the rate at which a crashing vehicle is decelerated below a predetermined value to safely stop the vehicle.

The present invention also includes a latching mechanism to prevent upward motion of the center of the guardrail structure, unless a direct frontal impact occurs. The latching mechanism keeps vehicles, during a side impact to the system from pocketing or snagging within the guardrail structure's scissors-like pivot mechanism. When the sled travels backward a predetermined distance, latches are released from the guiderails.

The end treatment of the present invention also includes preferably a wire cable transition which provides a smooth continuation from the end treatment to a fixed barrier to virtually any shape. The cables are positioned so that the vertical/radial displacement of the guardrail lattice structures due to their scissors-like pivoting action will bring them slack. Returning the guiderail structure to its rest position automatically retensions the cables.

### BRIEF DESCRIPTION OF THE DRAWINGS

FIG. 1 is a plan view of the redirective end treatment of the present invention showing the end treatment positioned along side a roadway.

FIG. 2A is a side elevational view of the end treatment in its rest position.

FIG. 2B is a cross-sectional, side elevational view of the end treatment in its rest position taken along the lines 2B-2B shown in FIG. 1.

FIG. 2C is a cross-sectional, side elevational view of the end treatment taken along the lines 2B-2B shown in FIG. 1 in which the impact sled has moved backward and impacted the smart braking unit.

FIG. 2D is a cross-sectional, side elevational view of the end treatment taken along the lines 2B-2B shown in FIG. 1 as the end treatment begins to pivot in response to a vehicle hitting the impact sled.

FIG. 2E is a cross-sectional, side elevational view of the end treatment taken along the lines 2B-2B shown in FIG. 1 wherein the amount of linear space occupied by the end treatment is reduced due to a scissors-like folding of the structure.

FIG. 3 is a partial enlarged plan view of the impact sled engaging the smart braking unit and a portion of the first lattice structure positioned behind the impact sled and braking unit.

FIG. 4 is a side elevational cutaway view of the smart braking unit showing the boost pressure apparatus and the energy absorbing buffer mounted within the braking unit.

FIG. 5 is a cross-sectional view of the impact sled taken along the lines 5-5 shown in FIG. 2A.

FIG. 6 is a cross-sectional view of the guardrail structure taken along lines 6-6 shown in FIG. 2A.

FIG. 7A is a partial side view of the guardrail structure taken at detail 7A shown in FIG. 2A.

FIG. 7B is a partial plan view of the guardrail structure taken at detail 7B shown in FIG. 2A.

FIG. 8A is an enlarged partial plan view of the redirective end treatment of FIG. 1 showing its mid-section from above.

FIG. 8B is an enlarged partial plan view of the redirective end treatment of FIG. 1 showing its mid-section from below.

FIG. 8C is an enlarged partial side elevational view of the redirective end treatment of FIG. 2B showing its mid-section.

FIG. 9 is a schematic of the preferred braking system used in the end treatment of the present invention.

FIG. 10A is a cross-sectional view of the inertial deceleration sensor valve used in the end treatment preferred braking system in an inactivated position.

FIG. 10B is a cross-sectional view of the inertial deceleration sensor valve of FIG. 10A in an active position wherein the impact sled has been decelerated to a predetermined g-force level.

FIG. 10C is a cross-sectional view of the inertial deceleration sensor valve of FIG. 10A in an active position wherein the g-force induced by the braking system has exceeded a specified level.

FIG. 11 is a schematic of an alternative braking system used in the end treatment of the present invention.

### DESCRIPTION OF THE PREFERRED EMBODIMENT

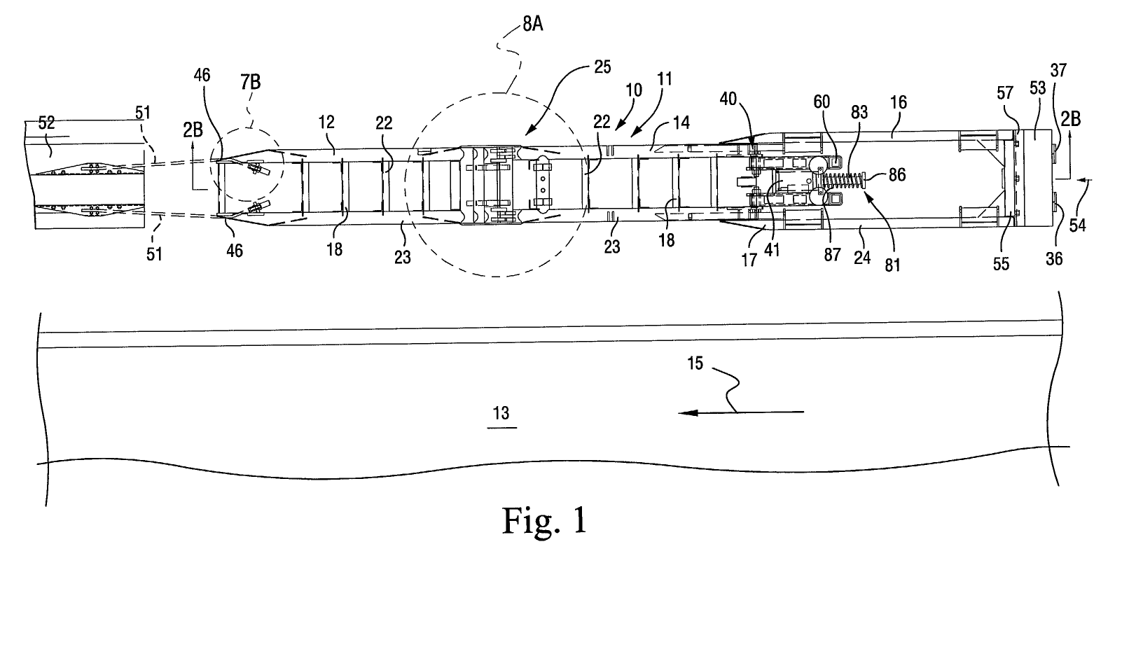

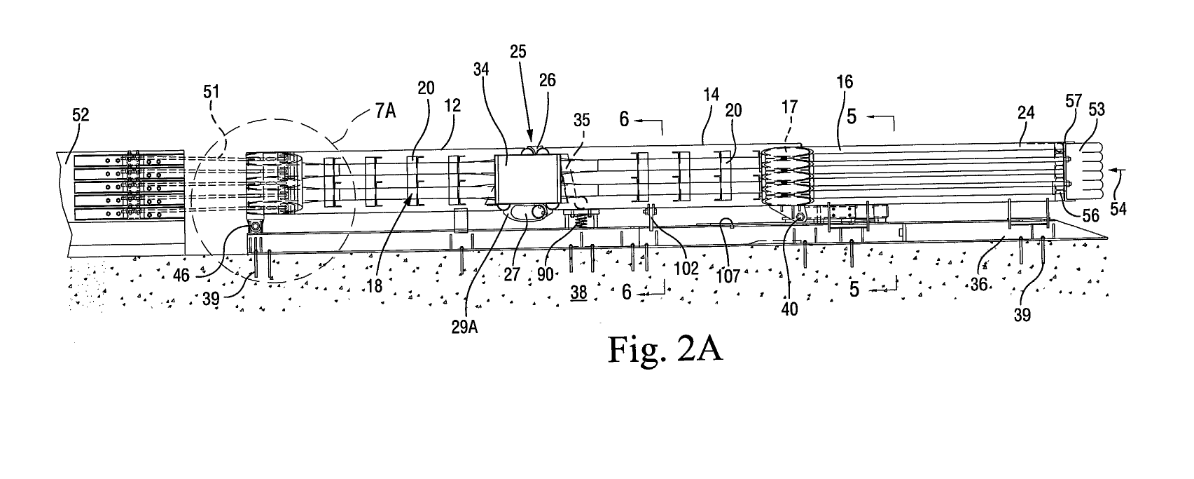

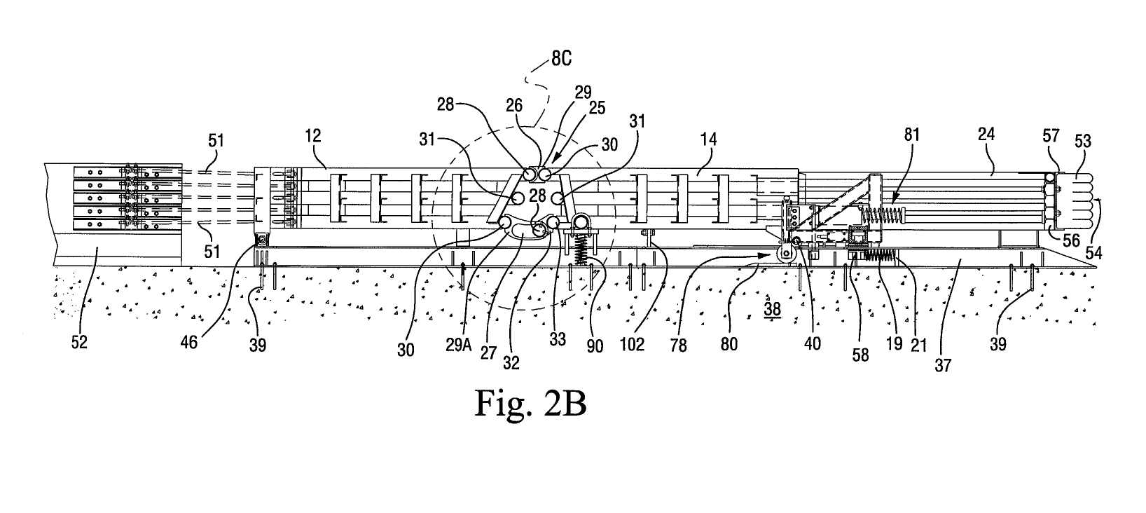

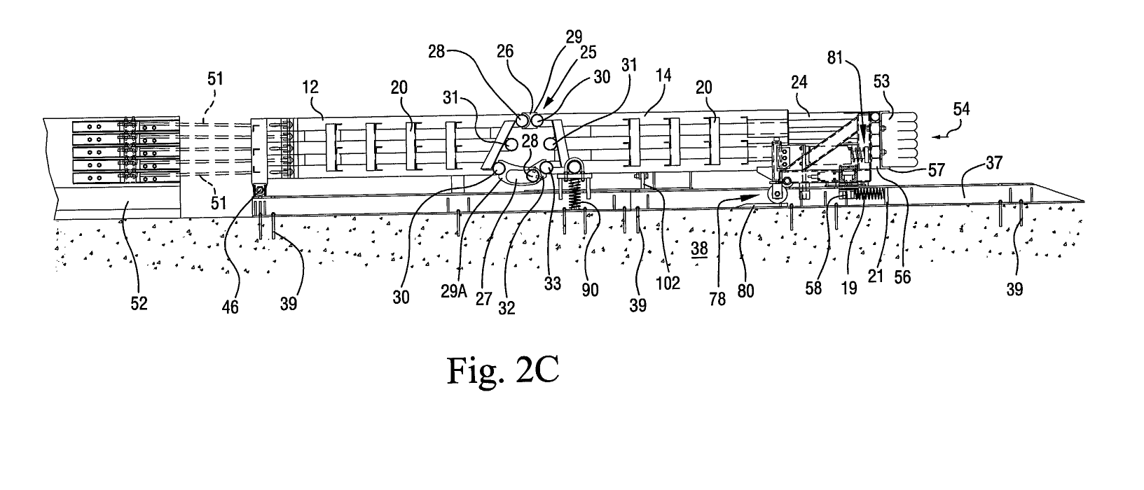

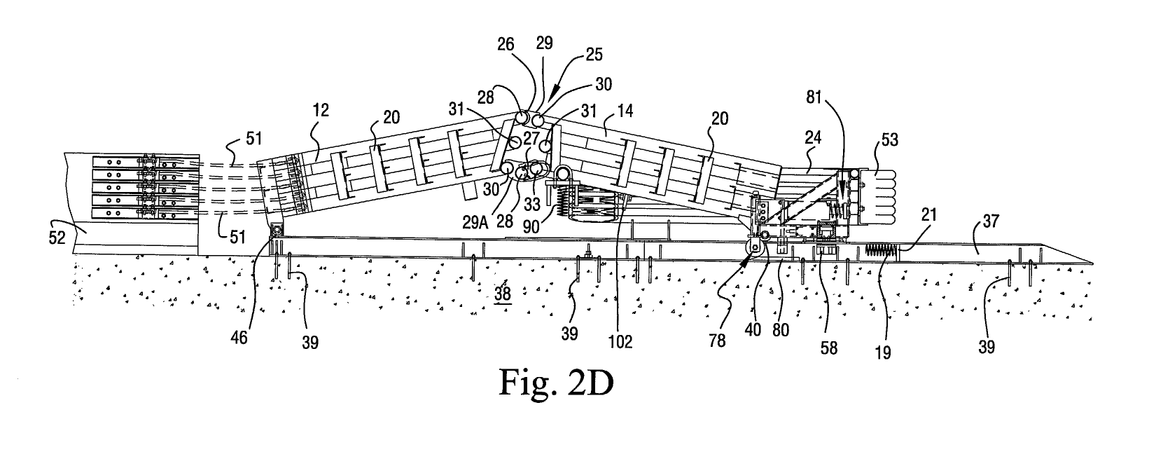

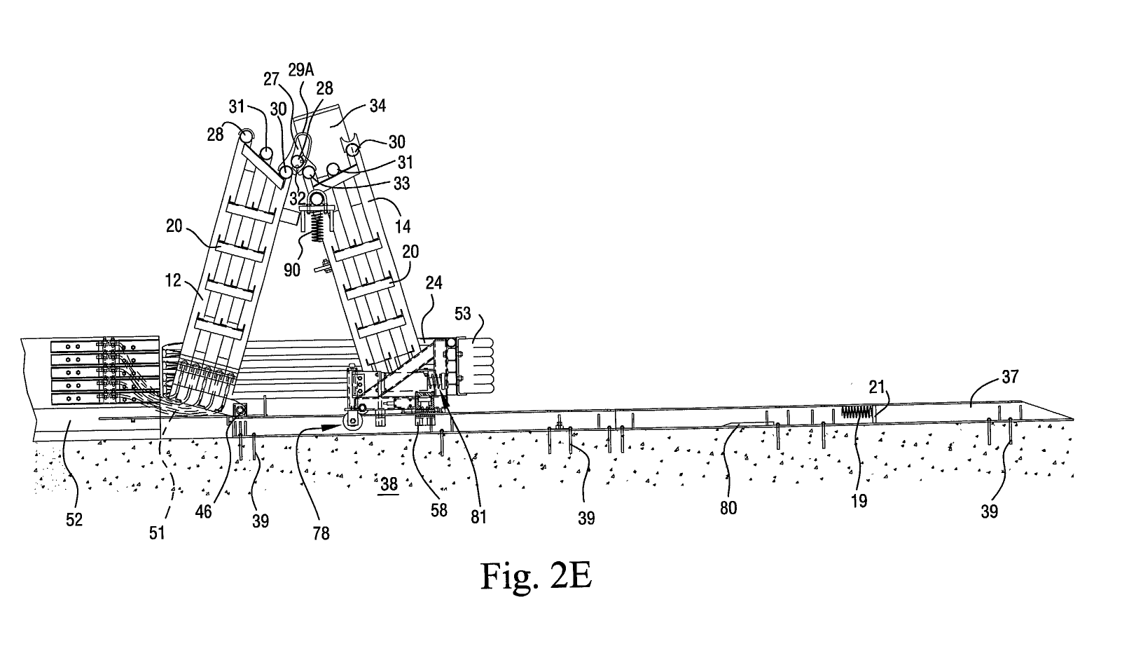

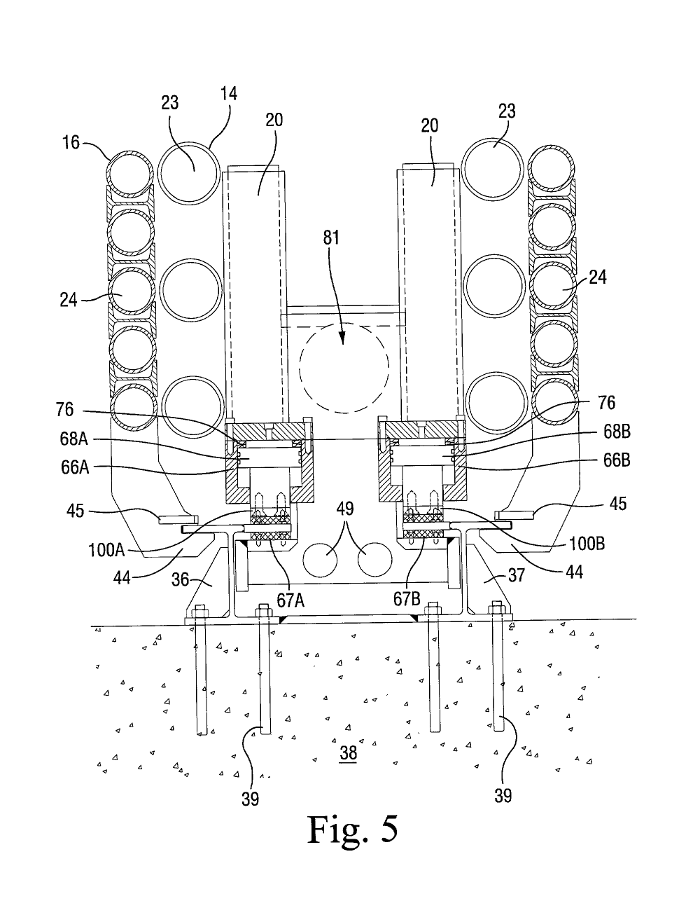

The present invention is a vehicle crash barrier that initially limits the velocity at which an unrestrained occupant of a crashing vehicle impacts the vehicle's dashboard and that subsequently actively controls the rundown rate of deceleration at which the vehicle impacting the barrier will come to a stop. FIG. 1 is a plan view of the redirective end treatment 10 of the present invention in a rest position. FIG. 2A is a side elevational view of end treatment 10 in the same rest position. FIG. 2B is a cross-sectional, side elevational view of the end treatment 10 in the rest position taken along the lines 2B-2B shown in FIG. 1. Referring first to FIGS. 1, 2A, and 2B, end treatment 10 includes an elongated guardrail structure 11, consisting of two guardrail frames 12 and 14, and an impact sled 16 that is positioned ahead of guardrail frames 12 and 14. As shown in FIGS. 1, 2A, and 2B, impact sled 16 and guardrail frames 12 and 14 are positioned longitudinally with respect to one another, with a portion 17 of impact sled 16 overlapping the front of guardrail frame 14, as shown in FIGS. 1 and 5. End treatment 10 is typically positioned along side a roadway 13 and oriented with respect to the flow of traffic 15 in roadway 13 as shown in FIG. 1.

Guardrail frames 12 and 14 are each constructed using steel lattice frames 18, each of which is constructed from a plurality of substantially parallel vertical frame members 20 preferably welded together with a plurality of substantially parallel cross-frame members 22 for structural rigidity. Preferably, vertical frame members 20 and cross-frame members 22 are L-section steel beams often referred to as “angle irons”. Welded to the outsides of vertical frame members 20 are a plurality of steel tubular members 23 preferably positioned at the top, bottom and middle of vertical frame members 20. Steel tubular members 23 are shown as having a circular cross-section, although other cross-sectional shapes, such as square or rectangular, could be used. Preferably, the spacing between tubular members 23 is small enough to prevent any vehicle impacting guardrail structure 11 from becoming trapped between members 23. Impact sled 16 is constructed from a plurality of substantially parallel steel tubular members 24 that are smaller in diameter than tubular members 23. In guardrail frames 12 and 14, there are preferably three rows of tubular members 23. In impact sled 16, there are preferably five rows of tubular members 24.

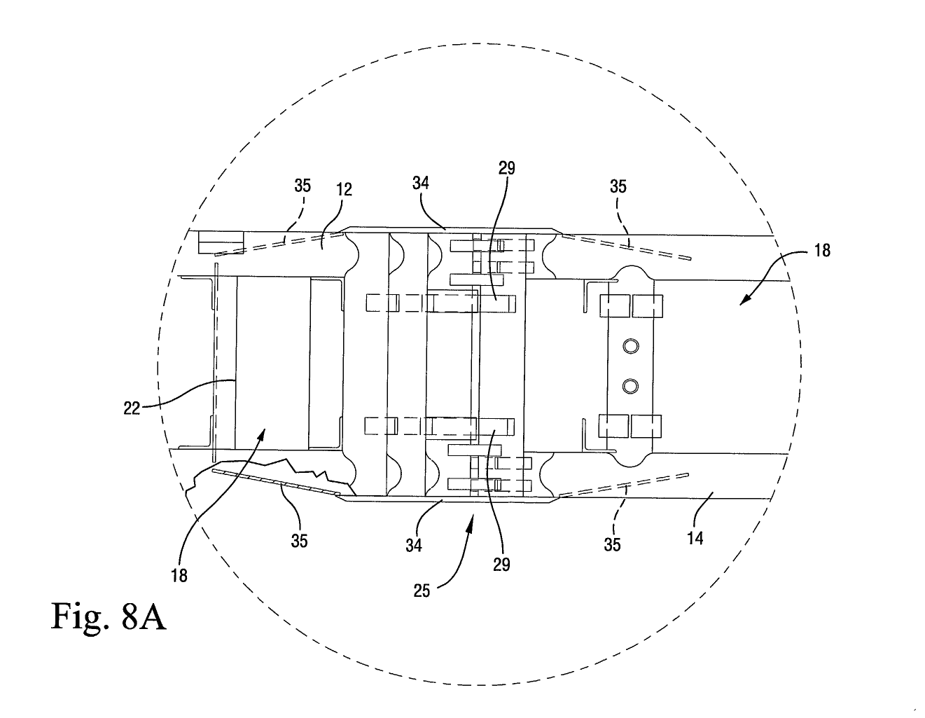

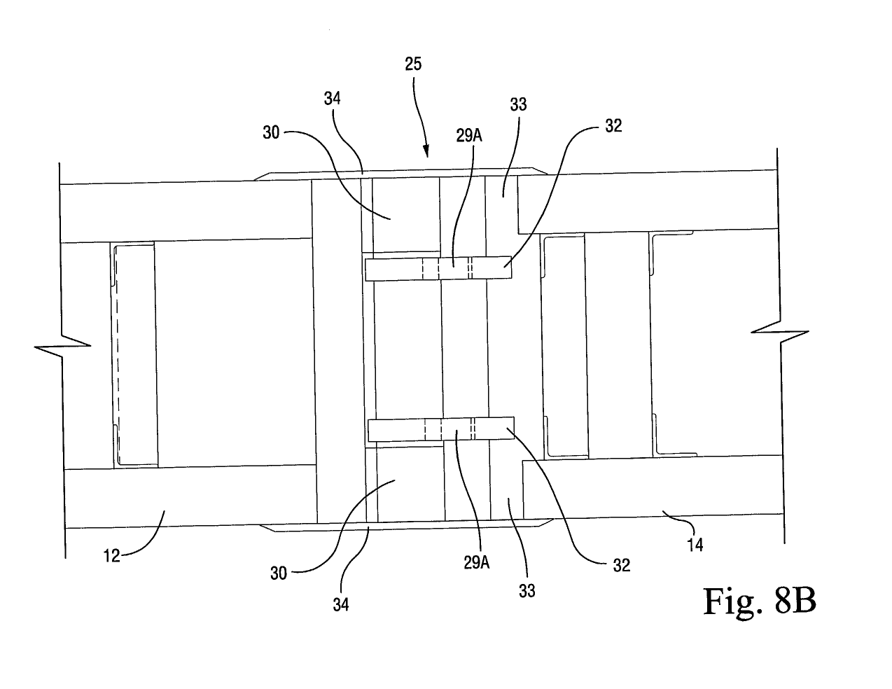

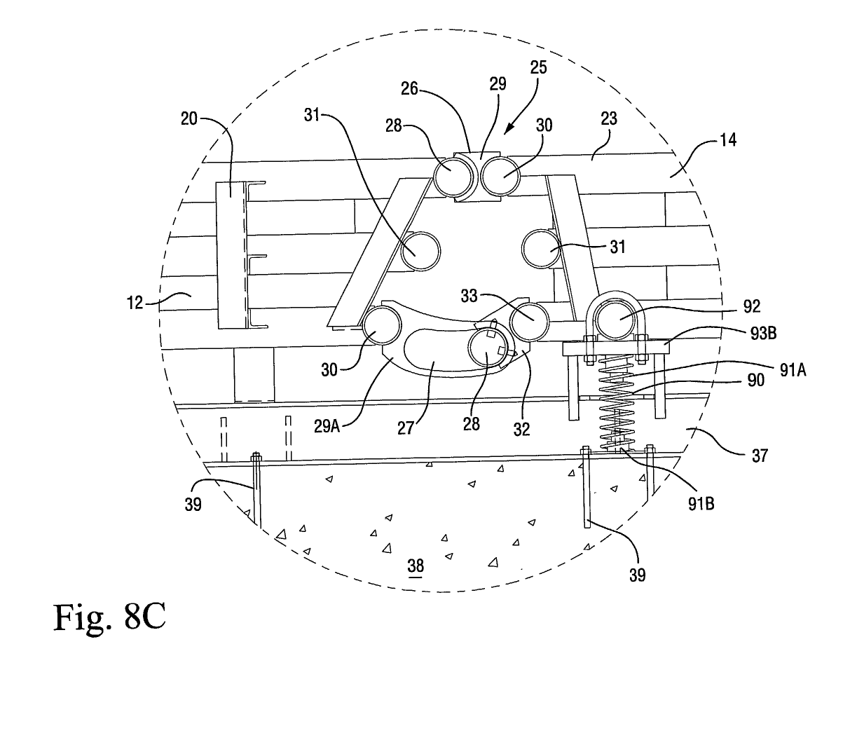

Guardrail frames 12 and 14 are not rigidly joined to one another, but interact with one another at a center pivot arrangement 25 shown in FIGS. 2B-2E which includes two pivot points 26 and 27. The details of pivot arrangement 25 are shown in FIGS. 8A, 8B, and 8C. Each of pivot points 26 and 27 includes a spindle 28. Spindle 28 of pivot point 26 is journaled in a pair of U-shaped flanges 29 welded onto a tubular member 30 which is welded to and a part of the lattice structure 18 forming guardrail frame 14. Spindle 28 of pivot point 27 is slidably journaled in a pair of crescent-shaped loops 29A welded onto a tubular member 30 which, in turn, is welded to and a part of the lattice structure 18 forming guardrail frame 12. Two additional tubular members 31 serve to terminate the center portions of the lattice structures 18 of guardrail frames 12 and 14. Tubular members 31 are also welded to their respective frames 18 and are not designed to engage one another. In addition, lower spindle 28 of guardrail frame 14 is also attached to a pair u-shaped flanges 32 welded to a tubular member 33 that is part of the lattice frame 18 comprising guardrail frame 14.

Also shown in FIGS. 2A, 8A and 8B are steel guard plates 34 and deflection plates 35 which are positioned on each side of pivot arrangement 25. The function of guard plates 34 is to prevent a vehicle that may laterally strike the end treatment 10 from becoming entrapped or snagged in the pivot arrangement 25 shown in detail in FIG. 8C. In the preferred embodiment of the invention, one of guard plates 34 are welded onto the sides of guardrail frame 14. The function of deflection plates 35 is to prevent vehicles that may laterally strike guardrail frames 12 and 14 near pivot arrangement 25 from becoming entrapped or snagged in between tubular members 23 near pivot arrangement 25. For this purpose, there are positioned on each side of guard plates 34 two deflection plates 35 welded in between adjacent rows of tubular members 23, shown in FIGS. 8A-8C.

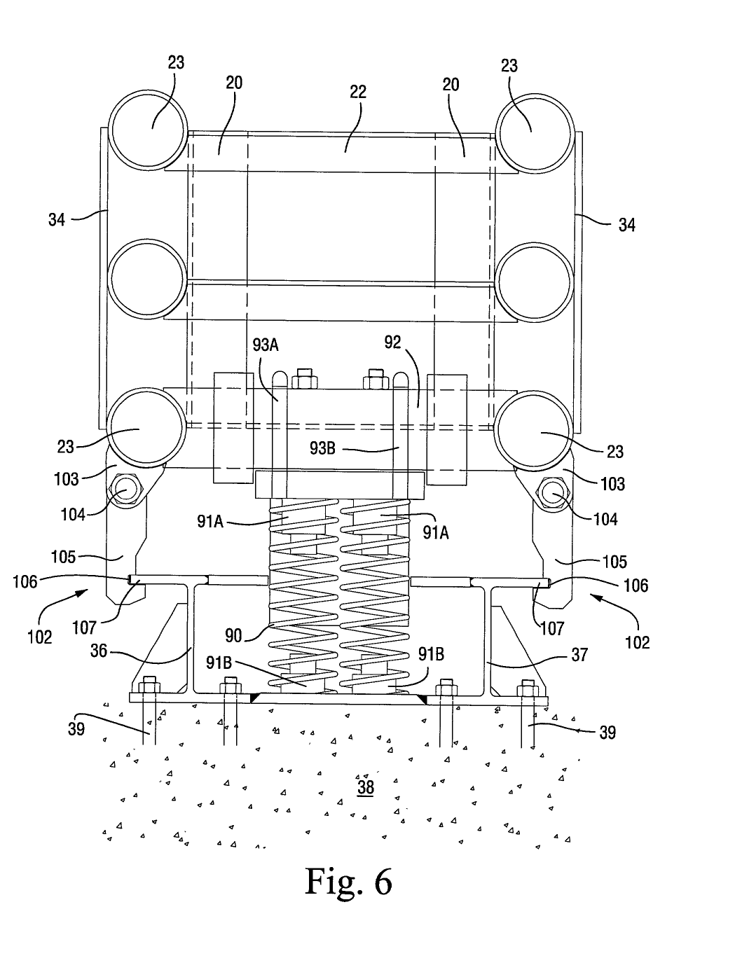

Guardrail frames 12 and 14 and impact sled 16 all rest on two generally parallel steel guide/brake rails 36 and 37 that are attached to the ground 38 by means of anchors 39 (See, e.g., FIG. 6) positioned at selected intervals along the lengths of rails 36 and 37. Anchors 39 are typically bolts in a suitable material (not shown), such as concrete or asphalt, that has been buried in the ground. This material may be in the form of a strip extending the length of the End Treatment.

As shown in FIGS. 1, 2B-2E, and 3, attached to the front of guardrail frame 14 at a third pivot point 40 a smart braking unit 41 positioned within impact sled 16 and ahead of guardrail frame 14, as shown in FIGS. 1 and 5. Pivot point 40 is comprised of double hinges 42 positioned on both sides of braking unit 41. Each of hinges 42 includes a bolt 42A journaled and held within a flange 43 by a nut 42B. Flange 43 is welded to tubular member 23 of guardrail frame 14.

As shown in FIGS. 2A-2E and 5, impact sled 16, guide rail frames 12 and 14, and smart braking unit 41 ride along guide/brake rails 36 and 37 partially on slides 44, each of which includes tabs 45 that engage the upper portion of I-beam shaped rails 36 and 37.

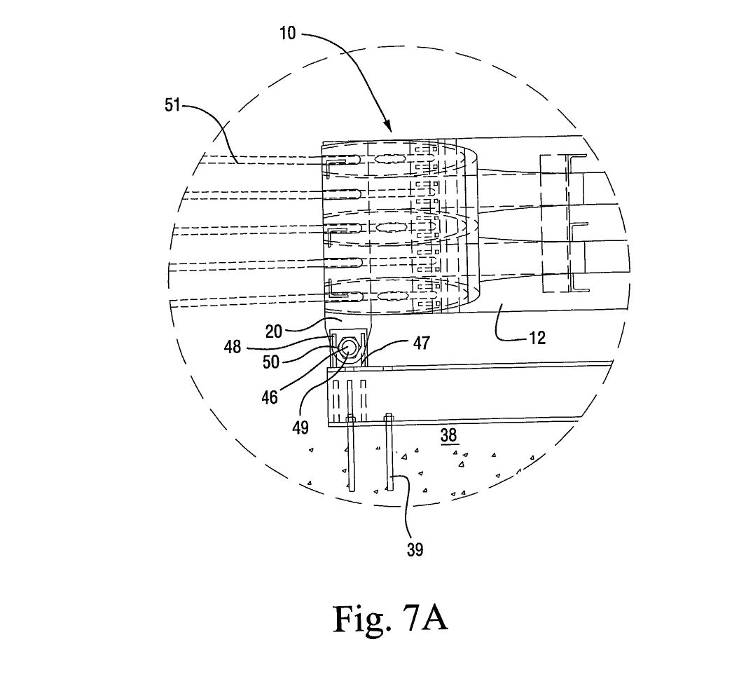

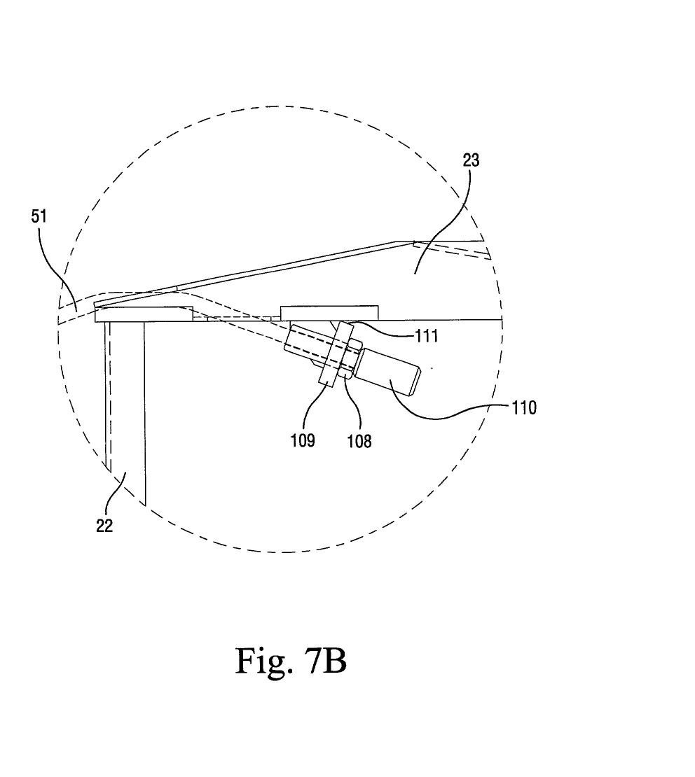

As shown in FIGS. 2A-2E, the back end of guardrail frame 12 is also pivotally connected at pivot point 46 to brake/guiderails 36 and 37. This connection is shown in greater detail in FIG. 7A. Pivot point 46 actually consists of two pivot points (not shown) through which guardrail frame 12 is pivotally connected to guide/brake rails 36 and 37. As noted above, guide/brake rails 36 and 37 are each shaped like an I-beam. On the top surface of each of guiderails 36 and 37 is welded a flange 47, which serve as vertex about which an additional flange 48 attached to a vertical frame member 20 of guardrail frame 12 rotates. Each of flanges 47 and 48 are rotatably joined together by a bolt 49 onto which is threaded a nut 50.

Positioned above each of pivot points 46 are preferably a series of galvanized wire cables 51 which serve as a transition from end treatment 10 to a fixed obstruction shielded by end treatment 10, such as a concrete barrier 52 shown in FIGS. 1 and 2A through 2E.

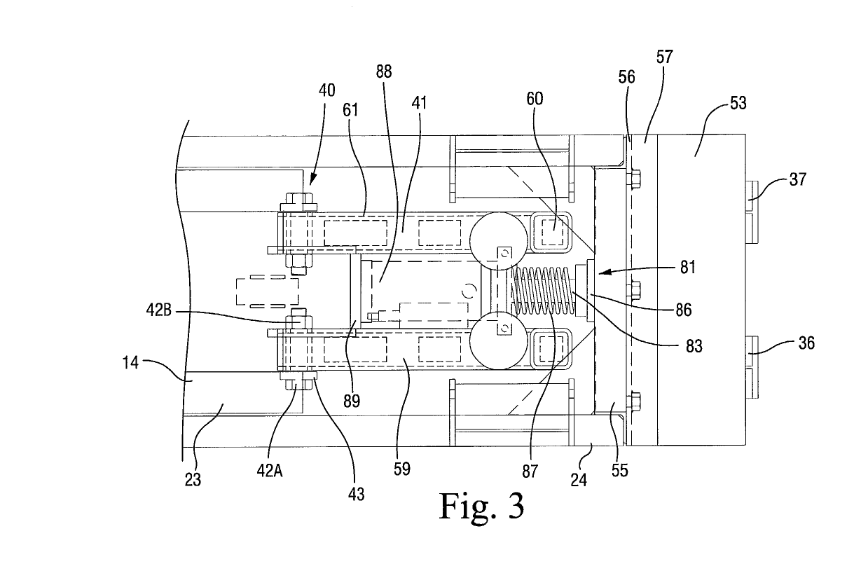

Impact sled 16 also includes an elastomer impact surface 53 which in the preferred embodiment is an elastomer bumper designed to receive the force of a vehicle (not shown) impacting the end treatment 10 as the vehicle moves in the direction of travel shown by arrow 54. Elastomer bumper 53 is designed to absorb a predetermined amount of energy such that the heaviest vehicle will compress the elastomer approximately 6″. This serves to cushion an initial spike in the g-force caused by the impact sled 16 accelerating to meet the speed of the impacting vehicle. Elastomer bumper 53 is mounted on frame 57 which is bolted to a plurality of laterally oriented tubular support members 55. Support members 55 are located within a vertically oriented support frame 56 welded to the plurality of longitudinally oriented tubular support members 24, as best seen in FIG. 3.

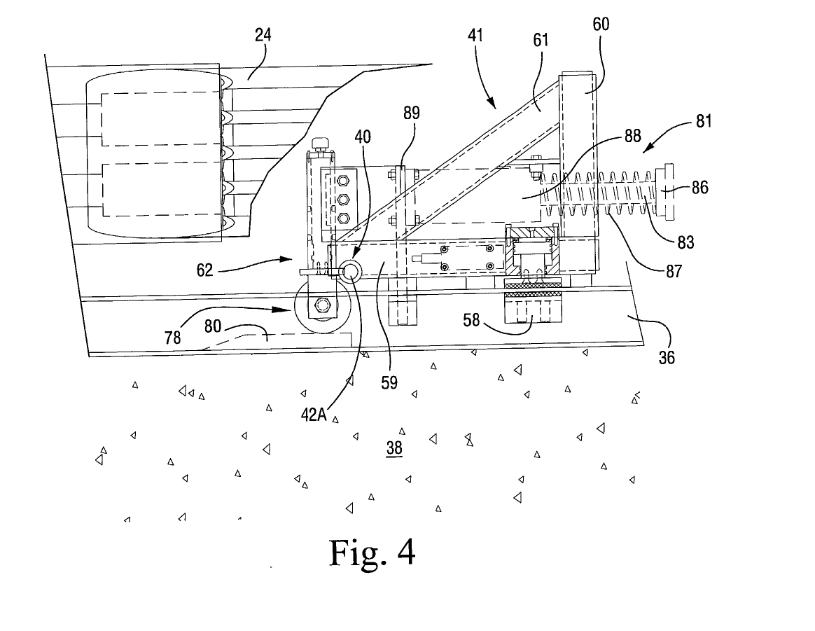

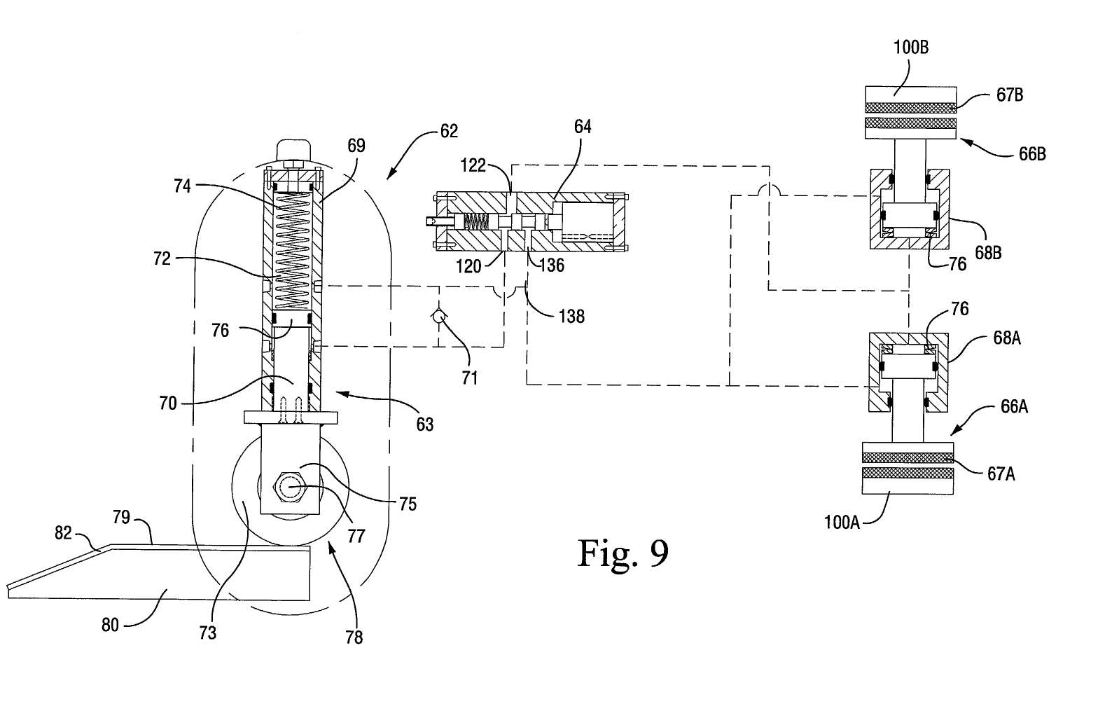

Pivotally attached to the front of guardrail frame 14 is smart braking unit 41, which is used by the end treatment 10 to control the speed at which end treatment 10 decelerates a vehicle crashing into it. Referring to FIGS. 3 and 4, smart braking unit 41 includes a horizontally oriented base support member 59 and vertically oriented members 60 braced by a quasi-vertical members 61. Braking unit 41 also preferably includes a hydraulic braking system 62, the components of the preferred embodiment of which are best shown in FIG. 9. Alternatively, the braking system could be a pneumatic system.

Braking system 62 includes a boost pressure source apparatus 63, shown within a dashed oval in FIG. 9. Apparatus 63 is connected to a g-force sensing valve 64, also shown in FIG. 9. Braking system 62 also includes two sets of brakes, 66A and 66B, that move along and engage the two rigid guide/brake rails 36 and 37 (See FIG. 5), and that apply a braking force to brake rails 36 and 37 through brakepads 67A and 67B, respectively. Brakes 66A and 66B each have a hydraulic piston or brake cylinder 68A and 68B, respectively, that applies the braking pressure generated by operation of the boost pressure source apparatus 63.

Boost pressure source apparatus 63 includes a cylinder 69 including a high pressure chamber 70 connected to a bleed valve 71 and a low pressure chamber 72 including a pressurizing spring 74 within chamber 72 and exerting a force on a piston head 76 movable within chamber 70. Cylinder 69 is supported, and thus spring 74 is compressed by, a roller assembly 78, which rides on a metal vane 80 having a predetermined height that extends for a predetermined distance 79 before changing to an inclined plane at point 82. Roller assembly 78 includes a flange 75 within which is mounted a wheel 73 on an axle formed by a bolt and nut arrangement 77. The g-force sensing valve 64 is also connected to bleed valve 71 and chamber 72.

When a vehicle impacts the elastomer bumper 53 of impact sled 16, sled 16 is caused to translate backwards, whereupon it first hits an energy absorbing buffer 81 before impacting smart braking unit 41, as shown in FIGS. 2C and 3. Alternatively, buffer 81 could be replaced by an elastomer bumper similar to elastomer bumper 53 mounted on the front of impact sled 16. Brake unit 41's backward translation is assisted by a pair of compressed coil springs 19 mounted on a pair of supports 21 welded to guiderails 36 and 37. Coil springs 47 engage blocks 58 welded to smart braking unit 41.

Energy absorbing buffer 81 includes a piston 83 with a piston head 86. Piston 83 is surrounded by a compressible spring 87 and slidably mounted within a hollow chamber 88 designed to accept piston 83 as it moves backward when hit by impact sled 16. Chamber 88 is bolted onto a vertical structural member 89 welded onto braking unit 41.

Before sled 16 reaches braking unit 41, energy absorbing buffer 81 cushions the impact of sled 16 and braking unit 41 for approximately 8″ before contact is made between sled 16 and braking unit 41. As impact sled 16 continues to translate backwards with braking unit 41, guardrail frame 14 is moved backwards so as to begin to rotate about pivot point 40. This, in turn, causes guardrail frames 12 and 14 to initially pivot around pivot point 26 as they begin to move vertically in the scissors-like folding action, best shown in FIGS. 2C-2E. A pair of normally compressed coil springs 90 positioned substantially under the center of the guardrail frames 12 and 14 assist in the vertical movement of such frames by exerting a vertical force against such frames. The preferred force exerted by the springs is approximately 6800 lb., determined by iterative simulation of the performance of the End Treatment in dynamic finite element analysis. Referring to FIGS. 6 and 8C, coil springs 90 are each positioned between and over two pairs of positioning hubs 91A and 91B shown in FIG. 6. Hubs 91B are bolted to the ground by anchors 39. Hubs 91A are bolted to a cross support 92 by a pair of u-bolt clamps 93A and 93B. Cross support 92, in turn is welded between two lower tubular members 23.

As guardrail frames 12 and 14 continue to move vertically upward due to the scissors-like folding action, the interaction between the two frames at pivot point 26 ends, but continues at pivot point 27 until frames 12 and 14 are fully folded and vertically extended. (FIG. 2E). The result is that the amount of linear space occupied by impact sled 16, braking unit 41, and guardrail frames 12 and 14 is substantially reduced, as depicted in FIGS. 2B through 2E. In a vehicle crash situation, typically, impact sled 16, braking unit 41, and guardrail frames 12 and 14 will not be physically damaged, compressed or collapsed because of the manner in which they are designed to translate away from a crashing vehicle while guardrail frames 12 and 14 fold-up in a scissors-like pivoting movement. In addition, elastomer bumper 53 located at the front of impact sled 16, besides cushioning the initial g-force spike caused by the acceleration of sled 16, also protects the sled from localized damage due to point loads of the vehicle's bumper on the impact surface. As such, frames 12 and 14, braking unit 41, and sled 16 can be returned to their original rest position, as shown in FIGS. 1, 2A and 2B, for reuse upon release of the pressure in the braking system 62. The release of the pressure is achieved by manual release of the check valve 71. Guardrail frames 12 and 14, braking unit 41, and impact sled 16 are then retracted to their rest position, helped by action of the mass of the scissor-like pivot assembly 25 shown in FIG. 8C. By forcing the braking unit 41 over the vane 80, piston 76 within the boost pressure apparatus 63 draws the hydraulic pressure fluid back to its original position to thereby fully reset the system.

To comply with the design specifications published in NCHRP Report 350, an unsecured occupant in a colliding vehicle must, after travel of 0.6 meters (1.968 ft.) relative to the vehicle reach a preferred velocity not exceeding nine meters per second (92.52 ft. per sec.) relative to the vehicle. A velocity of 12 meters per second is allowable under Report 350. This design specification is achieved in the present invention by controlling the mass of impact sled 16 to achieve this occupant velocity for a crashing vehicle having a minimum weight of 1,800 lbs. and a maximum weight of 4,400 lbs. and by providing enough distance between impact sled 16 and smart braking unit 41 to insure that a vehicle occupant impacts the vehicle's dashboard before brake unit 41 is contacted by sled 16 and a braking force is produced by smart braking unit 41. Impact sled 16's mass and travel distance are determined for the above criteria using dynamic Finite Element Analysis simulations of the performance of the End Treatment.

When a vehicle collides inelastically with sled 16, which is initially at rest, sled 16 freely travels approximately four feet before it impacts brake unit 41, causing guardrail frames 12 and 14 to rotate about pivot points 26, 46 and 40. During this initial travel of sled 16, an unsecured occupant of a crashing vehicle will, after travel of 0.6 meters, reach a velocity relative to the vehicle that does not exceed preferably 9 meters per second, and not more than 12 meters per second.

The preferred braking system of the present invention uses a g-force sensing valve 64, also called an inertial deceleration sensor valve, to control the braking force exerted by the braking system by modulating brake pressure, such that the braking force or g-forces on sled 16, braking unit 41 and the impacting vehicle are controlled below a predetermined maximum value.

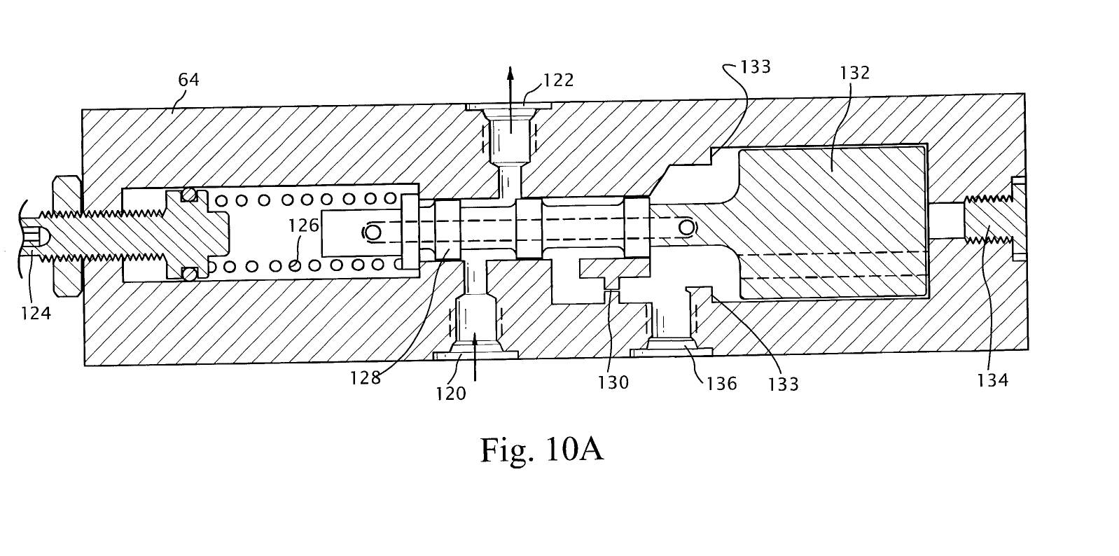

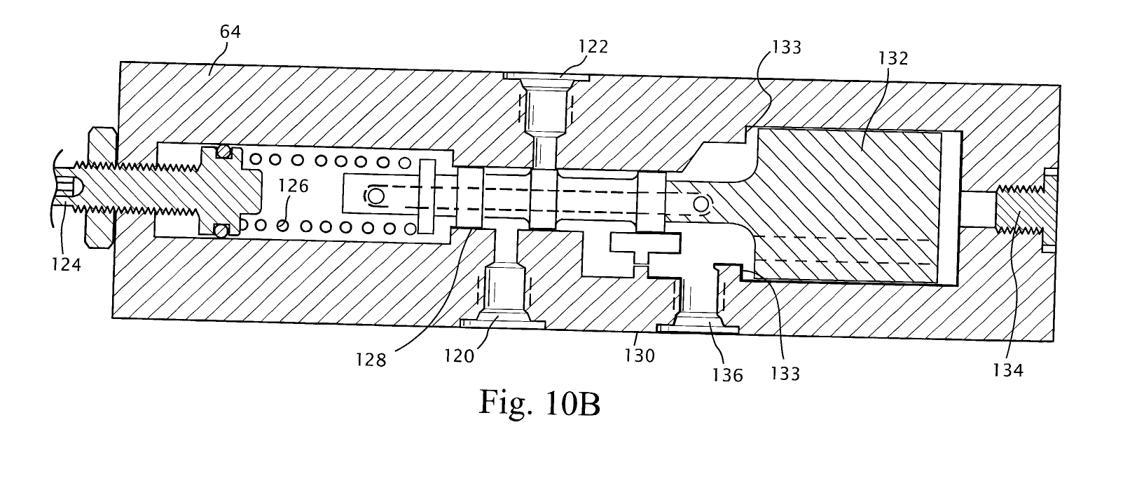

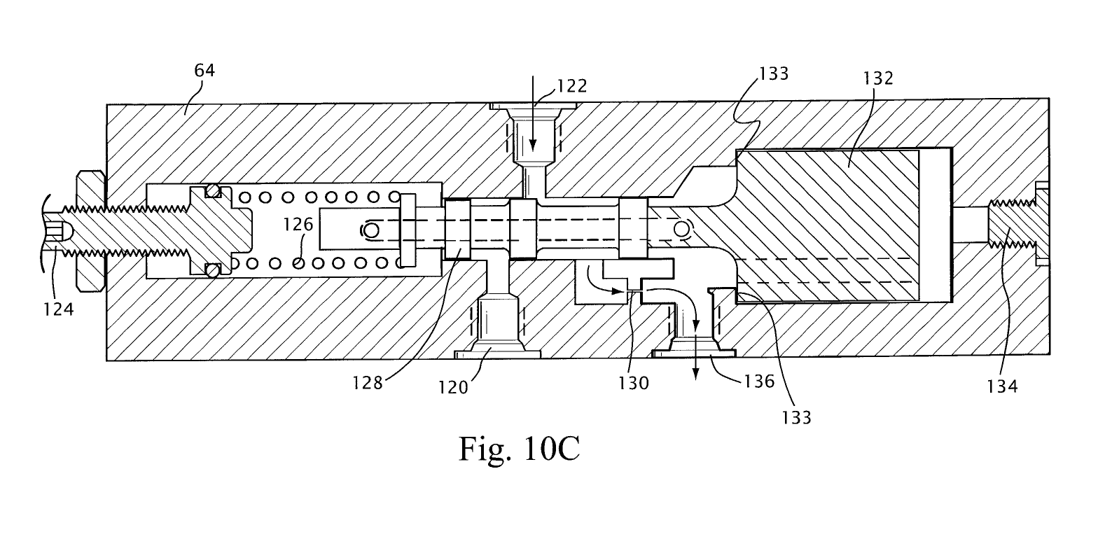

After sled 16 and braking unit 41 have translated the length of sheet metal vane 80, approximately a 5000 psi hydraulic brake pressure, generated by boost pressure apparatus 63, is sent through valve 64 (into port 120 and out of port 122 shown in FIGS. 10A-10C.). The braking effect at this high pressure is greater than the maximum g-force specified for the end treatment's braking system for most vehicles, since the maximum deceleration specified is between 6 and 9 g's.

Because g-force sensing valve 64 is mounted on sled 16, it sees all of the deceleration force imparted to sled 16 by brakes 66A and 66B. Valve 64 includes a spring force adjuster 124, a spring 126, a control spool 128, an orifice 130, an inertia weight 132, and an access plug 134.

FIG. 10A depicts valve 64 in the inactivated position, with weight 132 and control spool 128 being held to the right by the force of the compressed spring 126. This position allows for a free path for the brake fluid to pass through valve 64 from port 120 to port 122. Upon collision, the brake fluid will pass through this valve raising the brake pressure (and subsequent braking force) to a level that causes impact sled 16 to decelerate to a predetermined g-force level. Once the predetermined g-force level is reached, inertia weight 132 will overcome spring 126's preload force. This action will cause valve control spool 128 to move to the left, thus restricting the supply of fluid going to the brakes, as shown in FIG.10B. This limits the brake pressure to a level that achieves the predetermined g-force level for the system.

If the brake induced g-force exceeds the predetermined level, spool 128 will move further to the left (FIG. 10C), opening a path for the brake fluid under the high pressure to exit the brakes from port 122 through port 136. Port 136 is connected through lines 138 (FIG. 9) to a reservoir 74 under low pressure. Orifice 130 is placed in the pathway between port 122 and port 136 to limit the rate of flow through valve 64 to reduce the rate that the brake pressure falls off in this condition. This restriction reduces the amount of lost fluid when the valve modulates the brake pressure.

Valve 64 attempts to modulate the brake pressure at a predetermined g-force level. Inertia weight 132 has physical stops 133 in its travel to increase the natural frequency of valve 64, which improves the response time of the braking system.

Access port plug 134 can be removed to allow a force to be imparted to inertia weight 132 to simulate a g-force. By putting a pressure gauge in port 122 and connecting a pressure source to port 120, the spring force adjustment screw 124 can be adjusted to preset valve 64 so that the braking system cuts off at the prescribed g-force level.

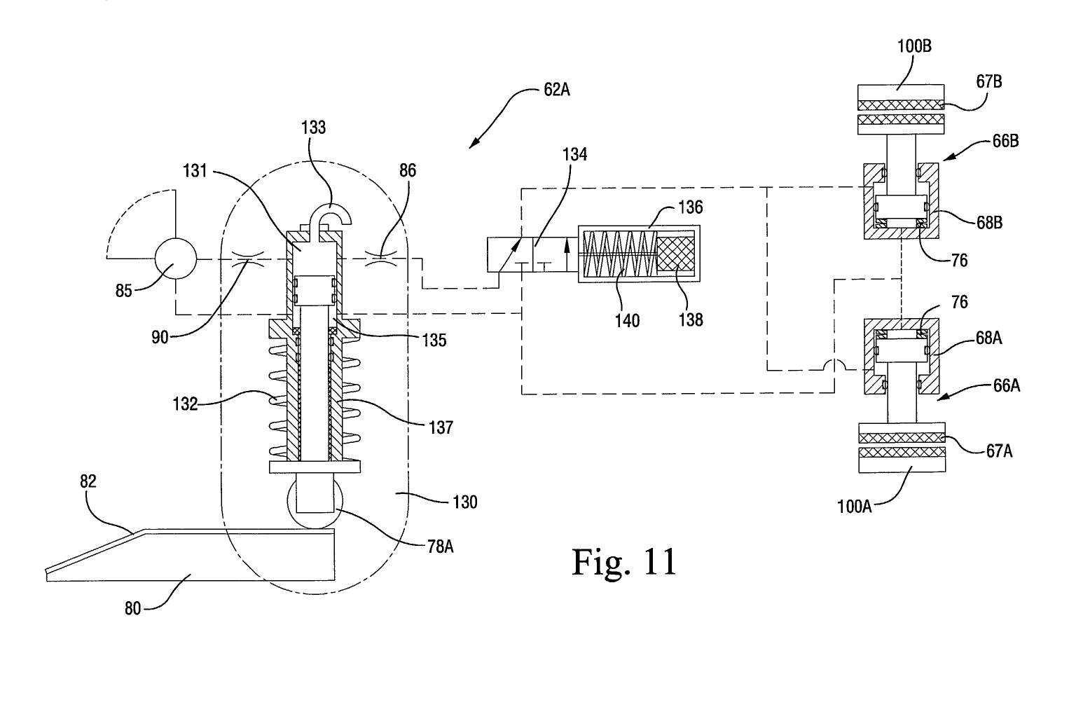

An alternative braking system 62A shown in FIG. 11, also includes a boost pressure apparatus 130. Boost pressure source apparatus 130 includes a zero pressure chamber 131 filtered through a vent tube 133 and a high pressure chamber 135 sitting on top of a pressurizing spring 132 surrounding shaft guides 137. Spring 132 is supported and thus compressed by a roller assembly 78A, which rides on a metal vane 80.

After sled 16 and brake unit 41 have translated the length of sheet metal vane 80, boost pressure source apparatus 130 is released when roller assembly 78A drops off of vane 80 at incline point 82. A pressurizing spring 132 is then released from compression and allowed to extend, thereby allowing the hydraulic pressure from boost pressure source apparatus 130 to build to its full amount, causing brake cylinders 68A and 68B to initially apply maximum braking force to brake rails 36 and 37. Rundown deceleration is then controlled by a deceleration sensing two-position pressure relief valve 134 mounted in an inertial deceleration sensor 136. Sensor 136 is mounted and aligned parallel to the travel track of brake unit 41. Valve 134 opens an amount controlled by the force of the crashing vehicle to reduce the boost pressure to the brake cylinders when the rundown deceleration of the crashing vehicle exceeds the predetermined value, preferably 8 g's, but not to exceed 20 g's, as specified by NCHRP Report 350. This reduces the braking force so that the deceleration of the vehicle stabilizes below the predetermined value. Thus, the action of two-position valve 134 effectively varies the braking force applied by braking system 62A to insure that the brake force applied to decelerate a vehicle cannot be larger than that required to maintain the vehicle deceleration below the predetermined rate of deceleration.

As shown in FIG. 11, inertial deceleration sensor 136 consists of a constrained mass 138 pressing against a precompressed spring 140, which, in turn, is attached to valve 134. Mass 138 exerts a force on the spring 140 that is proportional to the deceleration of the vehicle and impact sled 16. Until the deceleration g-force approaches the predetermined value, mass 138 does not move, since it cannot overcome the preload of spring 140. Above the predetermined value of deceleration, mass 138 overcomes spring 140, and translates, causing valve 134 to open. Thus, in this alternative variable braking system, the rate at which a crashing vehicle is decelerated is again controlled to safely stop the vehicle.

As shown in FIGS. 5 and 9, braking systems 62 and 62A use two sets of brakes 66A and 66B that move along guide/brake rails 36 and 37, and that apply a braking force to such rails through brake pads 67A and 67B that engage rails 36 and 37. Brakes 66A and 66B are mounted near the front of braking unit 41; however, it is possible to position brakes 66A and 66B in other locations, such as near pivot point 40. Brake cylinders 68A and 68B, will each apply a force to a caliper 100A and 100B, respectively, and, thus, brake pads 67A and 67B that clamp rails 36 and 37, respectively. The calipers/brake pads and brake rails are preferably of conventional construction and operate similarly to the disk brakes in a modern automobile. Each brake preferably has a pair of belleville springs 76 (FIGS. 5, 9 and 11) that maintain proper seating of the brake pad to the rail, but does not add significantly to the braking force applied by braking systems 62 or 62A.

Although smart braking unit 41 is pivotally attached to the front of guardrail frame 14 in the preferred embodiment of the invention, other arrangements are possible. For example, braking system 62 could be mounted on impact sled 16, rather than on a separate unit, as with smart braking unit 41. In such an arrangement, the mass of impact sled 16 and braking system 62 would have to be such as to limit the velocity of an unsecured occupant of a crashing vehicle after 0.6 meters of travel to less than preferably 9 meters per second, but not more than 12 meters per second to meet the requirements of NCHRP Report 350.

Alternatively, end treatment 10's braking system could be a proportional braking system (not shown). In such an alternative braking system, the braking force applied to the guide/brake rails is directly proportional to the force with which a vehicle impacts end treatment 10. As such, the braking force would increase/decrease as the force with which the vehicle impacts end treatment 10 increases/decreases. Such an alternative braking system might include an impact sensor positioned on the front end of end treatment 10 that has a direct hydraulic coupling to the master cylinder of the braking system. The impact surface may be connected to a spring loaded piston that directly exerts pressure on the hydraulic fluid in the braking system. Such an arrangement would allow the force of a vehicle impacting the sensor to be directly transferred to the pressure within the braking system to increase the braking force used to stop a crashing vehicle. In another arrangement, the impact sensor could provide an electrical signal which controls a pump used to pump up the hydraulic pressure in the braking system. In any such arrangement, the operation of the braking system would have to be delayed for a sufficient period of time to allow an unsecured occupant of the crashing vehicle to impact the dashboard of the vehicle at the specified safe velocity before the braking system begins to exert braking pressure to stop the crashing vehicle. The vane and supporting wheel assembly of the preferred embodiment of the invention could be used for this purpose.

The End Treatment of the present invention also includes latching mechanisms 102 shown in FIG. 6 to prevent upward motion of the center of guardrail frames 12 and 14, unless a direct frontal impact occurs on impact sled 16. Latching mechanisms 102 keep vehicles, during a side impact to the end treatment 10, from pocketing or snagging within the scissors-like pivoting arrangement 25 used with guardrail frames 12 and 14. As shown in side elevational FIGS. 2A-2E, latching mechanisms 102 would be located on both sides of guardrail frame 14 just forward of pivot arrangement 25, and would be joined to a bottom tubular member 23 of guardrail frame 14 as shown in FIG. 6. For this purpose, a flange 103 welded to member 23 includes an opening for a bolt and nut arrangement 104 to pivotally mount a J-shaped latch 105 with a notch 106 for engaging the top 107 of I-beam-shaped guiderails 36 and 37. When impact sled 16 travels backward a predetermined distance, a wedge 107 (FIG. 2D) forces latches 105 outward, releasing them from guiderails 36 and 37. In FIG. 6, latches 105 are shown in a locked position. Any impact that does not deflect impact sled 16 the predetermined distance will not release latches 105.

In the preferred embodiment of the invention, wire cables 51 provide a smooth continuation from end treatment 10 to a fixed barrier 52 of virtually any shape (See FIGS. 1, 2A-2E and 7A). Cables 51 are positioned so that axial displacement of impact sled 16 and braking unit 41 due to impact of a vehicle and the resulting scissors action of guardrail structures 12 and 14 shown in FIGS. 2B through 2E will bring cables 51 slack. Returning guardrail frames 12 and 14 and impact sled 16 to their rest position, as shown in FIGS. 1, 2A and 2B, automatically retensions cables 51. As shown in FIG. 7B, cables 51 are bolted within tubular members 23. For each cable 51, a bolt 108, through which cable 51 passes, is threaded into a plate 109 with a shoulder 111 that engages tubular member 23. A terminal 110 attached to the end of cable 51 is rotatably engaged by bolt 108. As bolt 108 is thread into or out of plate 109, the tension of cable 51 is either decreased or increased. Cables 51 are terminated on steel brackets mounted to barrier 52. (FIGS. 1 & 2A).

Although galvanized cables 51 are used in the preferred embodiment of the invention, such cables can be replaced by more rigid structural members (not shown) connected between guardrail frame 12 and barrier 52.

Although the present invention has been described in terms of a particular embodiment, it is not intended that the invention be limited to that embodiment. Modifications of the disclosed embodiment within the spirit of the invention will be apparent to those skilled in the art. The scope of the present invention is defined by the claims that follow.

What is claimed is:

1. A vehicle crash barrier comprising:
a guide;
a first structure for bearing vehicle impacts slidably mounted on the guide;
a second structure slidably mounted on the guide behind the first structure, the second structure containing a pivot arrangement which allows the second structure to fold in a scissors-like action; and
a braking system for applying to the guide a varied braking force to decelerate the vehicle at or below a predetermined rate of deceleration.

2. The crash barrier recited in claim 1, wherein the first structure and the braking system have a mass and a travel distance between them that limits the velocity at which an unsecured occupant of the vehicle impacts the vehicle's dashboard.

3. The crash barrier recited in claim 1, wherein the braking system is comprised of:
at least one brake acting on the guide to apply the braking force;
a first apparatus for boosting the braking force a predetermined amount; and
a second apparatus for decreasing the braking force when the deceleration rate of the vehicle exceeds a predetermined value.

4. The crash barrier recited in claim 3, wherein the second apparatus increases the braking force when the rate of deceleration of the vehicle is below the predetermined value.

5. The crash barrier recited in claim 3 wherein the second apparatus includes an inertial deceleration sensor valve for decreasing or increasing brake pressure.

6. The crash barrier recited in claim 3 wherein the second apparatus includes a two position inertial deceleration sensor valve for decreasing brake pressure

7. The crash barrier recited in claim 1, wherein the braking force applied by the braking system is controlled by the force of the impacting vehicle.

8. The crash barrier recited in claim 1, wherein the guide is at least one guide/brake rail attached to a plurality of anchors in the ground.

9. The crash barrier recited in claim 1, wherein the second structure is comprised of two elongated lattice structures which are longitudinally oriented and which pivot about one another in the folding scissors-like action in response to a vehicle colliding with the crash barrier.

10. The crash barrier recited in claim 8, wherein an end of one of the lattice structures is pivotally joined to the at least one guide/brake rail for rotation when a vehicle collides with the crash barrier.

11. The crash barrier recited in claim 1 wherein the second structure further includes at least one spring mechanism to assist the scissors-like folding action.

12. The crash barrier as recited in claim 11 wherein the spring mechanism is a pair of coil springs acting near a center of the second structure.

13. The crash barrier recited in claim 1 wherein the first structure further includes at least one spring mechanism to assist rearward travel of the first structure when the vehicle impacts the first structure.

14. The crash barrier as recited in claim 13 wherein the spring mechanism is a pair of coil springs acting at a front of the first structure.

15. The crash barrier recited in claim 1, further comprising a transition structure connecting the second structure to another structure not part of the crash barrier.

16. The crash barrier recited in claim 1, wherein further comprising an elastic padding mounted on the front of the first structure to receive the impact of a vehicle colliding with the crash barrier.

17. The crash barrier recited in claim 9, wherein each of the two lattice structures is comprised of a plurality of deflection members mounted on a plurality of support members joined together by a plurality of cross-members.

18. The crash barrier recited in claim 1, wherein the pivot arrangement is comprised of a first pivot joint about which the second structure first rotates to begin the scissors-like fold in response to a vehicle first colliding with the system and a second pivot joint about which the second structure rotates to complete the scissors-like fold.

19. The crash barrier recited in claim 1, wherein the guardrail structure is further comprised of at least two deflection plates shielding the pivot arrangement.

20. The crash barrier recited in claim 1, wherein the braking system is supported on a travel unit that is slidably mounted on the guide and pivotally attached to the second structure to induce the second structure to fold in the scissors-like action in response to the vehicle colliding with the crash barrier.

21. The crash barrier recited in claim 1 wherein the braking system applies to the guide a braking force that is proportional to the force with which the vehicle collides with the first structure.

22. The crash barrier recited in claim 1 further comprising at least one latch releasably connecting the second structure to the guide to prevent upward motion of the second structure by a vehicle striking the crash barrier in a direction other than a direct frontal impact.

23. A system for decelerating a vehicle comprising:
at least one guide rail;
an impact structure slidably mounted on the guide rail;
a frame structure slidably mounted on the guide rail and longitudinally oriented with respect to the impact structure, the frame structure containing a pivot structure which allows the frame structure to fold in a scissors-like action in response to a vehicle colliding with the system; and
a braking unit for applying to the guide rail a varied braking force in response to a vehicle colliding with the system.

24. The system for decelerating a vehicle recited in claim 23, wherein the braking unit is comprised of:
at least one brake acting on the guide rail to apply the braking force;
a first apparatus for initially boosting the braking force applied by the brake a predetermined amount; and
a second apparatus for subsequently increasing or decreasing the braking force applied by the brake so that the rate of deceleration of the vehicle reaches a predetermined value to maintain the deceleration of the vehicle at or below the predetermined value.

25. The system for decelerating a vehicle recited in claim 23, wherein the braking force subsequently applied by the braking unit is controlled by the force of the colliding vehicle.

26. The system for decelerating a vehicle recited in claim 23, wherein the at least one guide rail is two guide rails attached to a plurality of anchors in the ground.

27. The system for decelerating a vehicle as recited in claim 23, wherein the frame structure is comprised of two lattice frames which are arranged end-to-end and which pivotally interact with one another in a scissors-like folding action in response to a vehicle colliding with the system.

28. The system for decelerating a vehicle as recited in claim 27, wherein an end of one of the two lattice frames is also pivotally joined to the at least one guide rail for rotation when a vehicle collides with the system.

29. The system for decelerating a vehicle recited in claim 23, further comprising a wire cable transition connected between the frame structure and a fixed obstruction.

30. The system for decelerating a vehicle recited in claim 23, wherein the impact structure is positioned in front of the frame structure to receive the impact of a vehicle colliding with the system.

31. The system for decelerating a vehicle recited in claim 23, wherein the impact structure includes an elastic padding mounted on the front of the impact structure to receive the impact of a vehicle colliding with the system.

32. The system for decelerating a vehicle as recited in claim 27, wherein each of the two lattice frames is comprised of a plurality of tubular members mounted on a plurality of support members joined together by a plurality of cross-members.

33. The system for decelerating a vehicle recited in claim 23, wherein the pivot structure is comprised of a first pivot joint about which the frame structure first rotates to begin the scissors-like fold in response to a vehicle first colliding with the system and a second pivot joint about which the frame structure subsequently rotates to complete the scissors-like fold.

34. The system for decelerating a vehicle recited in claim 23, wherein the frame structure is further comprised of at least two deflection plates shielding the pivot structure.

35. The system for decelerating a vehicle recited in claim 23, wherein the braking unit is pivotally attached to the frame structure to allow the frame structure to fold in the scissors-like action in response to the vehicle colliding with the system.

36 The system for decelerating a vehicle recited in claim 23, wherein the braking unit applies to the guide rail a braking force that is proportional to the force with which the vehicle collides with the system.

37. The system for decelerating a vehicle recited in claim 23 further comprising at least one latch bar releasably connecting the frame structure to the guide rail to prevent upward motion of the frame structure by a vehicle striking the system in a direction other than a direct frontal impact.

38. The system recited in claim 24 wherein the second apparatus includes an inertial deceleration sensor valve for decreasing or increasing brake pressure.

39. The system recited in claim 24 wherein the second apparatus includes a two position inertial deceleration sensor valve for decreasing brake pressure.

40. The system recited in claim 23 wherein the frame structure further includes at least one spring mechanism acting on the frame structure to assist the scissors-like folding action.

41. The system recited in claim 40 wherein the spring mechanism is a pair of coil springs.

42. The system recited in claim 23 wherein the impact structure further includes at least one spring mechanism acting on the impact structure to assist rearward travel of the impact structure when a vehicle impacts the impact structure.

43. The system recited in claim 42 wherein the spring mechanism is a pair of spring coils.

44. An end treatment comprising:
first and second brake rails attached to the ground;
a guardrail structure movably supported by the first and second brake rails and containing a first pivot structure so that the guardrail structure can fold in a scissors-like action in response to a vehicle impacting the system;
an impact sled movably supported by the first and second brake rails and positioned ahead of the guardrail structure;
a braking unit pivotally attached to the guardrail structure through a second pivot structure for applying a braking force to the brake rails in response to a vehicle colliding with the impact sled to maintain the rate of deceleration of the vehicle below a predetermined value.

45. The end treatment recited in claim 44, wherein the braking unit is comprised of:
first and second brakes acting on the brake rails;
an apparatus for boosting braking pressure applied to the first and second brakes; and
a deceleration sensing valve for adjusting the braking pressure applied to the first and second brakes when the deceleration of a vehicle colliding with the impact sled is different from the predetermined value so as to maintain the rate of deceleration of the vehicle at or below the predetermined value.

46. The end treatment recited in claim 45 wherein the braking force applied by the braking unit is controlled by the kinetic energy of the colliding vehicle.

47. The end treatment recited in claim 44 wherein the braking unit applies to the first and second brake rails a braking force that is proportional to the force with which the vehicle collides with the system.

48. The end treatment as recited in claim 44, further comprising a plurality of wire cables connected between the guardrail structure and a fixed obstruction in a roadway.

49. The end treatment recited in claim 44, wherein the guardrail structure is comprised of two framed structures pivotal relative to one another in a scissors-like action in response to a vehicle colliding with the impact sled.

50. The end treatment as recited in claim 49, wherein an end of one of the framed structures is also pivotally joined to the first and second brake rails for rotation in response to a vehicle colliding with the impact sled.

51. The end treatment recited in claim 44, wherein the impact sled is positioned in front of the guardrail structure to receive the impact of a vehicle colliding with the impact sled.

52. The end treatment recited in claim 44, wherein the impact sled includes an elastic padding mounted on the front of the impact sled to receive the impact of a vehicle colliding with the impact sled.

53. The end treatment recited in claim 44 wherein the guardrail structure is comprised of a plurality of tubular members mounted on a plurality of support members joined together by a plurality of cross-members.

54. The end treatment as recited in claim 53, wherein the guardrail structure is further comprised of first and second deflection plates mounted on the tubular members for shielding the first pivot structure from impact by vehicles.

55. The end treatment recited in claim 44, wherein the first pivot structure is comprised of a first pivot joint about which the frame structure rotates to begin the scissors-like fold in response to a vehicle first colliding with the impact unit and a second pivot joint about which the frame structure rotates to complete the scissors-like fold.

56. The end treatment recited in claim 44, wherein the impact sled has a combined mass that causes an unsecured occupant in the colliding vehicle to impact a dashboard of the vehicle at a velocity not exceeding the second predetermined value.

57. The end treatment recited in claim 56, wherein the impact sled is separated from the braking unit by a predetermined distance so that it travels the predetermined distance when struck by a vehicle so as to cause an unsecured occupant in the colliding vehicle to impact a dashboard of the vehicle at a velocity not exceeding the second predetermined value.

58. The end treatment recited in claim 44, further comprising at least one latch bar releasably connecting the deflection rail structure to the first and second brake rails to prevent upward motion of the guide rail structure by a vehicle striking the end treatment in a direction other than a direct frontal impact.

59. The end treatment recited in claim 44 wherein the second structure further includes at least one spring mechanism to assist the scissors-like folding action.

60. The end treatment as recited in claim 59 wherein the spring mechanism is a pair of coil springs acting near a center of the second structure.

61. The end treatment recited in claim 44 wherein the first structure further includes at least one spring mechanism to assist rearward travel of the first structure when the vehicle impacts the first structure.

62. The end treatment as recited in claim 61 wherein the spring mechanism is a pair of coil springs acting at a front of the first structure.

63. The end treatment as recited in claim 45 wherein the deceleration sensing valve is an inertial valve which decreases brake pressure when the deceleration of the vehicle colliding with the impact sled exceeds the predetermined value and which increases brake pressure when the deceleration of the vehicle is below the predetermined value.

64. The end treatment as recited in claim 45 wherein the deceleration sensing valve is a two position inertial valve which decreases brake pressure when the deceleration of the vehicle colliding with the impact sled exceeds the predetermined value.

65. A method for decelerating a vehicle that has left a roadway comprising:
providing a first structure with a predetermined mass to bear an impact by the vehicle and cause an unsecured occupant in the colliding vehicle to impact a dashboard of the vehicle at or below a predetermined velocity;
providing a second structure to fold in a pivoted scissors-like action in response to the vehicle colliding with the first structure; and
applying a varied braking force to decelerate the colliding vehicle and maintain the vehicle's deceleration at or below a predetermined rate of deceleration.

66. The method recited in claim 65, wherein the braking force applied to the guide rail is responsive to the kinetic energy of the colliding vehicle.

67. The method recited in claim 65, wherein a maximum braking force is initially applied and then a reduced braking force is applied that is responsive to the kinetic energy of the colliding vehicle.

68. The method recited in claim 65, wherein the braking force is applied to a guide which slidably supports the first and second structures.

69. The method recited in claim 68, wherein the braking force is applied to the guide by a braking system slidably supported by the guide.

70. The method recited in claim 65, wherein a maximum braking force is initially applied and then a reduced braking force is applied when the deceleration of the vehicle colliding with the impact sled exceeds the predetermined rate and wherein an increased braking force is applied when the deceleration of the vehicle is below the predetermined rate.

71. A vehicle crash barrier comprising:
first structural means for bearing vehicle impacts;
second structural means for folding in a scissors-like action;
means for slidably mounting said first and second structural means,
said second structural means being mounted on said mounting means behind said first structural means; and
means for applying to said mounting means a varied braking force to decelerate the vehicle at or below a predetermined rate of deceleration.

72. The crash barrier recited in claim 71, wherein the braking means is comprised of:
at least one means acting on the guide to apply the braking force;
means for boosting the braking force a predetermined amount; and
means for decreasing the braking force when the rate of deceleration of the vehicle exceeds a predetermined value.

73. The crash barrier recited in claim 72, further including means for increasing the braking force when the rate of deceleration of the vehicle is below the predetermined value.

74. The crash barrier recited in claim 73 wherein the means for decreasing the braking force and the means for increasing the braking force are an inertial deceleration sensor valve.

75. The crash barrier recited in claim 72 wherein the means for decreasing the braking force is a two position inertial deceleration sensor valve.

76. The crash barrier recited in claim 71 wherein the second structural means further includes at least one spring means for assisting the scissors-like folding action.

77. The crash barrier recited in claim 71 wherein the first structural means further includes at least one spring means for assisting rearward travel of the first structural means when the vehicle impacts the first structural means.

78. The crash barrier recited in claim 71, further comprising means for connecting the second structural means to another structure not part of the crash barrier.

79. The crash barrier recited in claim 71, further comprising means mounted on the front of the first structural means for receiving the impact of a vehicle colliding with the crash barrier.

80. The crash barrier recited in claim 71, wherein the crash barrier further comprised of deflection means for shielding against side impacts by a vehicle.

81. The crash barrier recited in claim 71 further comprising means for releasably latching the second structural means to the mounting means to prevent upward motion of the second structural means by a vehicle striking the crash barrier in a direction other than a direct frontal impact.

82. A braking system for decelerating a vehicle impacting a crash barrier, the braking system comprising:
a brake rail;
a brake acting on the brake rail to apply a braking force to the brake rail to thereby decelerate the vehicle at or below a predetermined rate of deceleration;
a first apparatus for boosting the braking force a predetermined amount; and
a second apparatus for decreasing the braking force when the rate of deceleration of the vehicle exceeds the predetermined value.

83. The braking system recited in claim 82, wherein the second apparatus increases the braking force when the rate of deceleration of the vehicle is below the predetermined value.

84. The braking system recited in claim 83 wherein the second apparatus includes an inertial deceleration sensor valve for decreasing or increasing brake pressure.

85. The braking system recited in claim 83 wherein the second apparatus includes a two position inertial deceleration sensor valve for decreasing brake pressure.

86. The braking system recited in claim 82, wherein the brake rail is mounted on a plurality of anchors in the ground.

87. The braking system recited in claim 82, further comprising a support unit slidably mounted on the brake rail, the brake, first apparatus and second apparatus being mounted on the support unit.

88. A braking system for decelerating a vehicle impacting a crash barrier, the braking system comprising:
means for receiving a brake force;
means for applying a braking force to the brake force receiving means to thereby decelerate the vehicle at or below a predetermined rate of deceleration;
means for boosting the braking force a predetermined amount; and
means for decreasing the braking force when the rate of deceleration of the vehicle exceeds a predetermined value.

89. The braking system recited in claim 88, further comprising means for increasing the braking force when the rate of deceleration of the vehicle is below the predetermined value.

90. An inertial deceleration sensor valve for a crash barrier braking system wherein the braking system applies a braking force to decelerate a vehicle at or below a predetermined rate of deceleration, the valve comprising:
an inertia weight;
a control spool connected to the inertia weight;
a spring for urging the control spool and inertia weight toward first respective positions within the valve, the spring allowing the control spool and inertia weight to move toward second respective positions within the valve when the valve is subjected to a predetermined g-force level;
a first path for a passage of brake fluid through the valve when the control spool and inertia weight are substantially in the first respective positions; and
a second path for a reduced passage of brake fluid through the valve when the control spool and inertia weight are substantially in the second respective positions.

91. The valve recited in claim 90 wherein the second path includes an orifice for reducing the rate of flow of the brake fluid through the second path.

92. The valve recited in claim 90 further comprising a spring force adjustment screw for adjusting the predetermined g-force level.

93. The valve recited in claim 90 further comprising an access port plug for allowing a force to be imparted to the inertia weight to simulate a g-force.

94. An inertial deceleration sensor valve comprising:
first means for passing brake fluid through the valve;
second means for restrictedly passing brake fluid through the valve;
means for controlling said passing of said brake fluid through said first and second passing means, said controlling means including means for urging said controlling means toward a first position within the valve,
said urging means allowing said controlling means to move from said first position toward a second position within the valve when the valve is subjected to a predetermined g-force level,
the first passing means passing brake fluid through the valve when said control means is in said first position; and
the second passage means passing brake fluid through the valve when said control means is in said second position, said second passage means including means for restricting the flow of brake fluid through said second passage means.

95. The valve recited in claim 94 further comprising means for adjusting the predetermined g-force level at which said controlling means moves from said first position to said second position.

96. The valve recited in claim 94 further comprising means for accessing said controlling means within said valve for allowing a force to be imparted to said controlling means to simulate a g-force.

97. The crash barrier recited in claim 5 wherein the inertial deceleration sensor valve comprises:
an inertia weight;
a control spool connected to the inertia weight;
a spring for urging the control spool and inertia weight toward first respective positions within the valve, the spring allowing the control spool and inertia weight to move toward second respective positions within the valve when the valve is subjected to a predetermined g-force level;
a first path for a passage of brake fluid through the valve when the control spool and inertia weight are substantially in the first respective positions; and
a second path for a reduced passage of brake fluid through the valve when the control spool land inertia weight are substantially in the second respective positions.

98. The crash barrier recited in claim 97 wherein the second path includes an orifice for reducing the rate of flow of the brake fluid through the second path.

99. The crash barrier recited in claim 97 further comprising a spring force adjustment screw for adjusting the predetermined g-force level.

100. The crash barrier recited in claim 97 further comprising an access port plug for allowing a force to be imparted to the inertia weight to simulate a g-force.
